(19) United States
(12) Patent Application Publication
(10) Pub. No.: US 2025/0238883 A1
(43) Pub. Date: Jul. 24, 2025

(54) AI CONTEXTUAL LEGAL MATTER AND COMPUTER-IMPLEMENTED TOOL

(71) Applicant: Lightning DEP INC. d/b/a Lightning Law, Carefree, AZ (US)

(72) Inventor: Alisa R. BRODKOWITZ, Carefree, AZ (US)

(21) Appl. No.: 18/419,312

(22) Filed: Jan. 22, 2024

(51) Int. Cl. G06Q 50/18; G06Q 10/1093

(52) U.S. Cl. CPC G06Q 50/18; G06Q 10/1095

(57) ABSTRACT

The technology disclosed herein relates to methods and systems that provide improved computing tools for analyzing legal matter data (e.g., for attorneys during a virtual meeting with a client or potential client). For example, legal matter data can include data corresponding to the client or potential client and another party that is relevant to a legal issue. The improved computing tools can include a legal analyzer (e.g., capable of identifying a legal issue within a particular set of legal matter data and a relevant electronic legal document within a data store that corresponds to the legal issue), a form generator (e.g., capable of identifying one or more legal forms, within a data store, that corresponds to the legal issue and automatically populating the legal form), and a question generator (e.g., capable of generating one or more questions based on the legal issue and a legal document).

### BACKGROUND

Many areas of law experience increased demand or other types of growth trajectories. For example, some areas of law can rapidly change or evolve based on market demand or other factors. Various technologies have emerged to assist with various legal services.

### SUMMARY

This summary provides a high-level overview of various aspects of the technology disclosed herein, and the detailed-description section below provides further description herein. This summary is not intended to identify key features or essential features of the claimed subject matter, nor is it intended to be used as an aid in isolation to determine the scope of the claimed subject matter. The present disclosure is directed, in part, to technology associated with improved artificial intelligence (AI) tools for managing legal matters and conducting a virtual meeting corresponding to a legal proceeding, substantially as shown in and/or described in connection with at least one of the figures, and as set forth more completely in the claims.

Embodiments discussed herein include methods, media, and systems that provide improved computing tools for analyzing legal matter data (e.g., for attorneys during a virtual meeting with a client or potential client). For example, legal matter data can include data corresponding to the client or potential client and another party that is relevant to a legal issue. As another example, the legal matter data can include data corresponding to a location associated with the client or potential client and the party relevant to the legal issue. In yet another example, the legal matter data can include data corresponding to circumstances associated with the legal issue (e.g., legal matter data, for a tort legal issue, corresponding to loss of past or future income, payment of medical expenses, payments associated with pain and suffering, etc.).

The improved computing tools discussed herein may include a legal intelligence system (e.g., capable of identifying a legal issue within a particular set of legal matter data and identifying a relevant electronic legal document within a data store that corresponds to the legal issue), a form generator (e.g., capable of identifying one or more legal forms, within a data store, that correspond to the legal issue and capable of automatically populating the legal form based on the legal matter data), and a question generator (e.g., capable of generating one or more questions based on the legal issue and particular legal rules within an electronic legal document). In embodiments, the question generator can provide one or more questions to an attorney to provide during the virtual meeting with the client or potential client. For example, based on identifying a particular legal issue within the legal matter data provided by the client or potential client and based on the identification of applicable legal rules (applicable to the legal issue) stored within the data store, one or more questions associated with fulfillment of a legal rule may be provided to the attorney via a user device during the virtual meeting.

In some embodiments, the legal issue can be identified using a trained machine learning model. As an example, the client or potential client can provide the legal matter data via a textual input or an audio input. In embodiments wherein the input is an audio input, an automatic speech recognition model can be used for identifying the legal issue. In some embodiments, the machine learning model can be trained using a training dataset that includes a plurality of legal issues that are clustered based on a category corresponding to each legal issue (e.g., a first category for a first type of negligence tort legal issue and a second category for a second type of negligence tort legal issue). In some embodiments, the one or more questions can be generated for an unfulfilled legal element for a particular legal issue for eliciting more legal matter data from a client based on using the machine learning algorithm that is trained using a set of electronic legal documents that each include a particular legal rule (e.g., wherein the training datasets are clustered based on a jurisdiction or based on a type of legal rule).

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Implementations of the present disclosure are described in detail below with reference to the attached drawing figures, wherein:

FIG. 1 depicts an example operating environment for a legal intelligence system, in accordance with embodiments herein;

FIGS. 2-9 illustrate examples of user interfaces for utilizing the legal intelligence system, in accordance with embodiments herein;

FIGS. 10-11 illustrate examples of particular legal information that is displayed based on utilizing the legal intelligence system, in accordance with embodiments herein;

FIG. 12 illustrates an example flowchart for utilizing the legal intelligence system, in accordance with embodiments herein; and

FIG. 13 depicts an example user device suitable for use in implementations of the present disclosure, in accordance with embodiments herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies.

Moreover, although the terms “step” and/or “block” may be used herein to connote different elements of methods employed, the terms should not be interpreted as implying any particular order among or between various steps herein disclosed unless and except when the order of individual steps is explicitly described.

In addition, words such as “a” and “an,” unless otherwise indicated to the contrary, may also include the plural as well as the singular. Thus, for example, the constraint of “a feature” is satisfied where one or more features are present.

Furthermore, the term “or” includes the conjunctive, the disjunctive, and both (a or b thus includes either a or b, as well as a and b).

“Computer storage media” does not comprise signals per se.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Further, the term “some” may refer to “one or more.” Additionally, an element in the singular may refer to “one or more.” The term “plurality” may refer to “more than one.”

The term “combination” (e.g., one or more combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

As used herein, the phrase “based on” shall be construed as a reference to an open set of conditions. For example, an example step that is described as “based on X” may be based on both X and additional conditions, without departing from the scope of the present disclosure. In other words, as used herein, the phrase “based on” shall be construed in the same manner as the phrase “based at least in part on.”

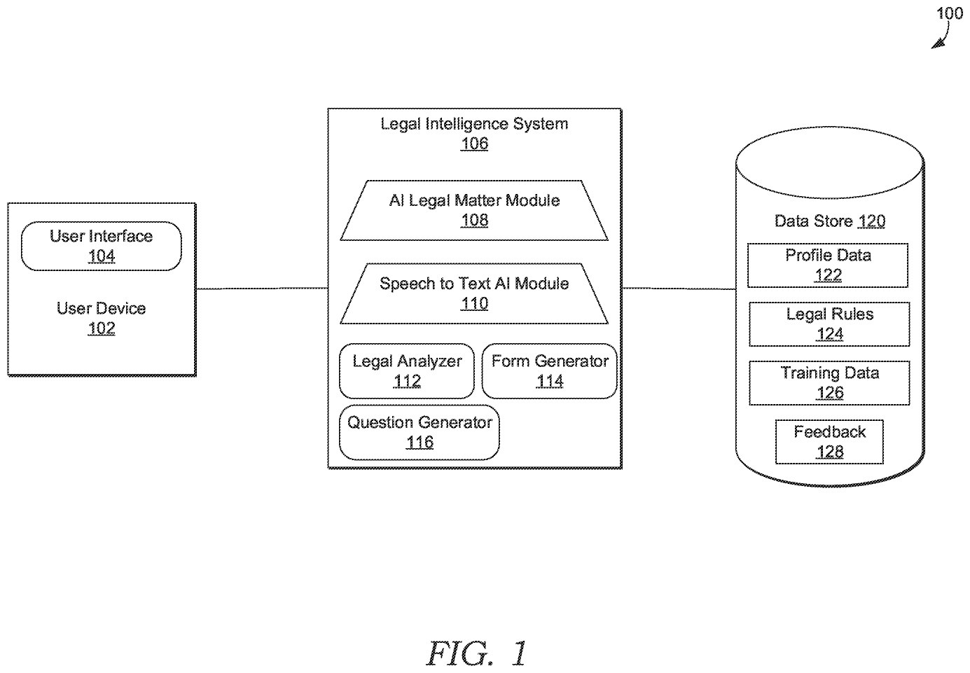

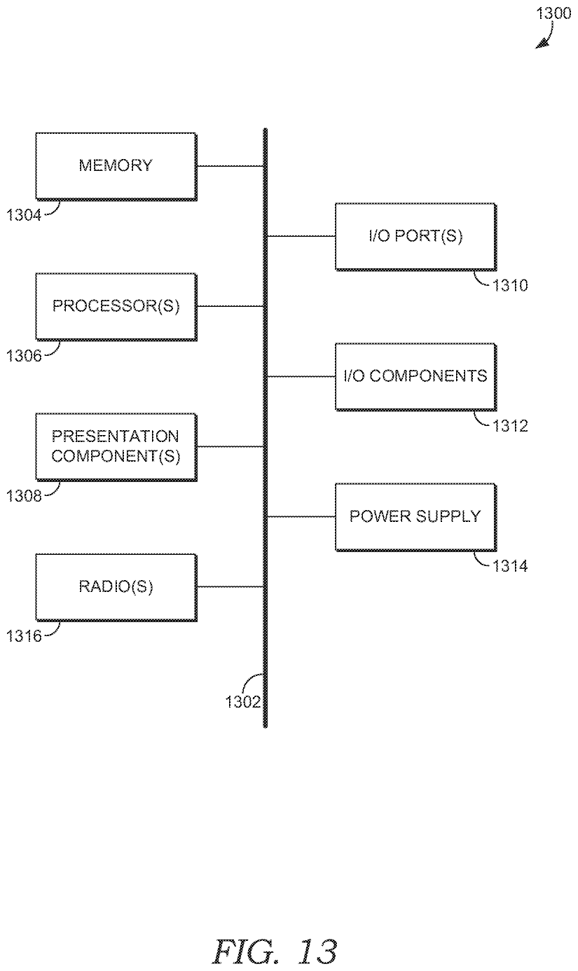

Additionally, a “user device,” as used herein, is a device that has the capability of transmitting or receiving one or more signals to or from a network node, and may also be referred to as a “computing device,” “mobile device,” “user equipment,” “client device,” “wireless communication device,” or “UE.” A user device, in some embodiments, may take on a variety of forms, such as a PC, a laptop computer, a tablet, an IoT device (e.g., a smart refrigerator, a smart air conditioner, a smart alarm system), a wearable device (e.g., a watch-type electronic device, a glasses-type wearable device), a mobile phone, a personal digital assistant, a server, another type of device that is capable of communicating with other devices (e.g., by transmitting or receiving a signal), or one or more combinations thereof. A user device may be, in some embodiments, user device 102 described herein with respect to FIG. 1 or user device 1300 described herein with respect to FIG. 13.

As used herein, “legal matter data” refers to data that is (or that can be) relevant to a legal issue, and a “legal issue” refers to a point of controversy or disagreement that may arise in the context of the law (e.g., a dispute, conflict, or violation of a law, contract, or regulation). A legal issue may involve one or more particular legal rules or one or more sets of legal rules, a remedy sought, a type of legal service sought, legal elements pertaining to a legal rule, and various factors for determining whether a particular legal element has been satisfied. For example, the legal issue of whether fraud was committed by an actor may include the legal elements of representation of fact, the falsity of the represented fact, the materiality of the represented fact, and the knowledge that the represented fact was indeed false, and the factors for determining the legal element(s) associated with knowledge may include descriptions within a case that provide examples for determining the knowledge. Legal matter data can, for example, include factual data, contract data, regulation data, a type of remedy sought, an amount of money to be recovered or received, particular legal services requested, other types of legal matter data, or one or more combinations thereof. Legal matter data can correspond to one or more stages of a legal proceeding (e.g., pretrial discovery, trial, appeal, arbitration, mediation, etc.). In some embodiments, the legal matter data may correspond to the client or potential client, another party that is relevant to a legal issue, a current or previous attorney associated with a particular legal proceeding that corresponds to the legal matter data, one or more witnesses, an arbitrator or mediator, a judge, one or more jurors, another person corresponding to the legal matter data, or one or more combinations thereof. As another example, the legal matter data can include location data for one of the people corresponding to the legal matter data, a particular jurisdiction associated with a prior legal proceeding, a particular jurisdiction indicated within a contractual document, another location corresponding to the legal matter data, or one or more combinations thereof.

As used herein, a “legal proceeding” can refer to a proceeding before a tribunal (e.g., a court, an administrative body, an administrative commission, an administrative judge, a hearing officer, etc.) constituted by a law. In some embodiments, a legal proceeding may include a congressional hearing (e.g., an impeachment proceeding). In some embodiments, a legal proceeding refers to a proceeding for litigation, arbitration, mediation, a legal action before an administrative decision-maker, or another type of procedural means of seeking redress from a tribunal or agency. In some embodiments, a legal proceeding can also include a proceeding that involves attorney-client privileged communications. For example, a legal proceeding can include a meeting in which protected, confidential communications are exchanged between attorney and client (or potential client) relating to legal advice or services for the client. The term “attorney-client privilege” protection may extend to any format of information exchanged during a privileged communication between the attorney and client, such as a verbal communication, a written correspondence, an email, a text message, or another form of conveying the privileged information.

As used herein, “jurisdiction” may refer to a particular rule or regulation that is applied based on a particular geographical area. For example, a particular court may have jurisdiction based on a particular geographical area in which the circumstances associated with the legal issue arose. In some embodiments, “jurisdiction” can refer personal jurisdiction, subject matter jurisdiction, or both. As an example, jurisdiction can correspond to a power that a particular court has to adjudicate a case and issue an order. As another example, jurisdiction can correspond to a territory in which a court or a governing body can exercise a power. In some embodiments, jurisdiction can correspond to original jurisdiction, concurrent jurisdiction, diversity jurisdiction, or one or more combinations thereof.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, artificial intelligence has been used for comparing documents that have simple semantic differences (e.g., comparisons of two words with similar meanings). Additionally, existing systems often rely on question-answer pairs, such that particular questions are paired with particular answers so that when a user submits a known question, these systems provide the previously-paired answer. Further, machine learning tools for analyzing data, such as legal data, have faced difficulties with both use and automation, since general data analytics contain many tasks or procedures that have not yet been fully automated. For example, prior predictive data analytics systems have attempted to provide legal automation tools that still have not been fully automated throughout each step. As such, it would be beneficial for technologies to implement higher degrees of automation throughout various processes in a legal proceeding.

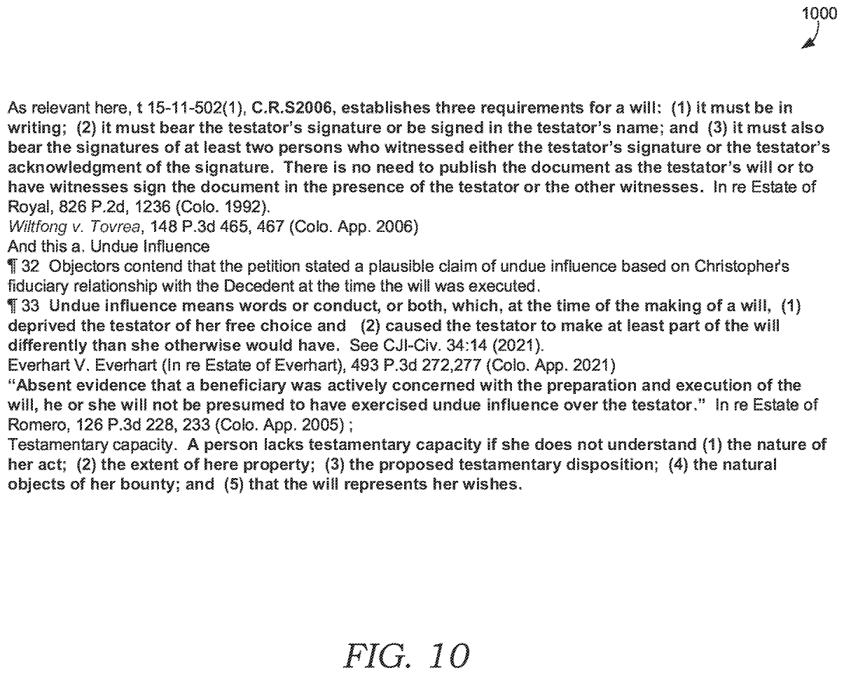

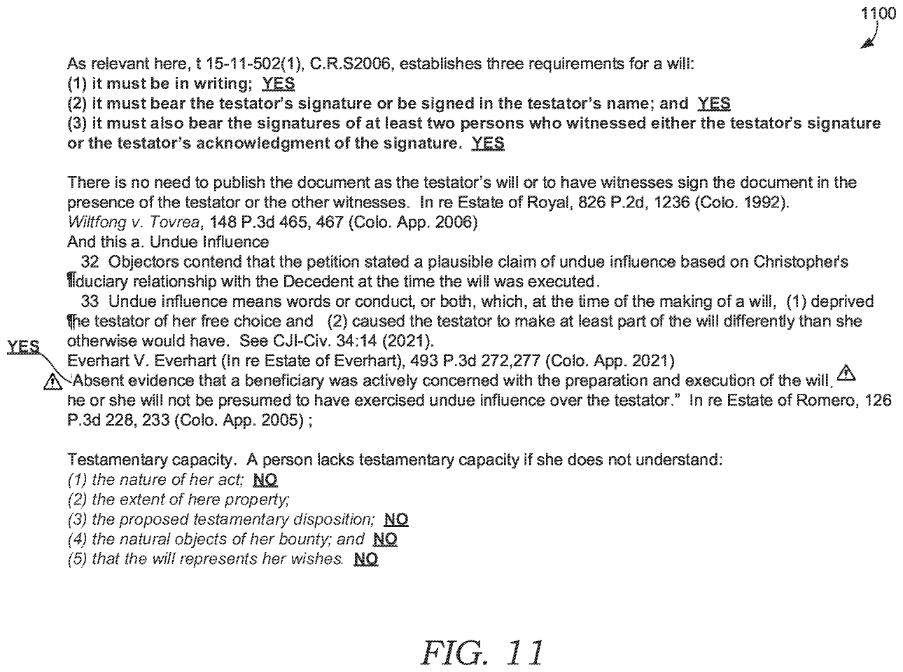

The present technology discussed herein provides for enhanced and intelligent computing tools that an attorney (or another legal professional), client (or a potential client), or another person involved in a legal proceeding can navigate at least a portion of the legal proceeding more efficiently or with more fine-tuned knowledge. For example, one embodiment of the technology discussed herein includes a system having one or more processors and computer memory storing computer-usable instructions that, when executed by the one or more processors, cause the system to perform operations. The operations may include receiving, from a user device, legal matter data. Based on receiving the legal matter data, the operations can further include identifying a jurisdiction and a legal issue. Based on identifying the jurisdiction and the legal issue, the system can analyze a set of data, using at least one machine learning algorithm, from at least one database that includes legal rules. Based on analyzing the set of data, the system can provide, to a user interface, particular legal information for display (two example embodiments of the particular information for display are illustrated in FIGS. 10-11).

In some embodiments, the particular legal information for display can be provided based on receiving an indication of a virtual meeting associated with the legal matter data. In some example embodiments, the virtual meeting can correspond to a virtual meeting in which attorney-client privilege applies to at least a portion of the virtual meeting (e.g., a discussion involving a particular time-frame during the virtual meeting includes the client or potential client discussing, showing, or messaging attorney-client privileged information). For example, the term “attorney-client privilege” includes protected, confidential communications between attorney and client (or potential client) relating to legal advice or services for the client. As another example, the term “attorney-client privilege” protection may extend to any format of information exchanged during a privileged communication, such as a verbal communication, a written correspondence, an email, a text message, or another form of conveying the privileged information.

In some embodiments, the system can analyze the set of data using a first machine learning algorithm (or a first set of machine learning algorithms) that is trained using a set of electronic documents (e.g., electronic case law, electronic statutes, electronic state constitutions, electronic ordinances) including tags for particular legal rules (e.g., particular case law rules tagged for a particular court, case law rules tagged for a particular type of law, such as contract law, case law rules tagged for a particular rule, such as rule against perpetuities), and the system can identify the jurisdiction and the legal issue using a second machine learning algorithm (or a second set of machine learning algorithms) that is trained using electronic documents that include tagged legal issues within each of the electronic documents. For example, in some embodiments, the second machine learning algorithm (or the second set of machine learning algorithms) is trained using previously-generated client engagement forms each having at least one tagged legal issue.

In some embodiments, based on identifying the jurisdiction and the legal issue (e.g., using the second machine learning algorithm or the second set of machine learning algorithms) and based on analyzing the set of data (e.g., using the first machine learning algorithm or the first set of machine learning algorithms), the system can retrieve one or more particular legal forms from one or more databases storing a plurality of legal forms. In some embodiments, the one or more particular legal forms are retrieved based on using a third machine learning algorithm (or a third set of machine learning algorithms) that is trained using a training dataset of legal forms having tags for a jurisdiction and tags for particular keywords associated with the legal issue, or tags for particular metadata associated with the legal issue. Based on the legal matter data received (e.g., from a client using a user device), the system can automatically populate a legal form using the legal matter data. In some embodiments, an automatic speech recognition model can automatically populate the legal form based on audio responses provided by the client during the virtual meeting.

In some embodiments, based on identifying the jurisdiction and the legal issue and based on analyzing the set of data, the system can provide one or more determined questions during the virtual meeting (or to a user device of an attorney before the virtual meeting, for example). To illustrate, the system can identify a particular set of legal rules applicable to the legal issue associated with the virtual meeting, and based on the legal matter data provided by the client or potential client or additionally based on audio responses provided by the client during the virtual meeting, the system can determine that there is missing information for one of the particular set of legal rules applicable. Based on determining that one of the legal rules has not been satisfied or requires more information, the system can generate one or more questions (e.g., using one or more machine learning models trained on datasets of legal rule and question pairs) and provide that question during the virtual meeting or to a particular user device prior to the virtual meeting.

In some embodiments, the virtual meeting, the generation of the one or more questions, the generation of the legal form, or one or more combinations thereof, can be initiated based on one or more profiles associated with one or more participants of the virtual meeting. For example, an attorney may have an attorney profile stored within one or more databases that the system can access. In embodiments, the attorney profile may include a bar license number, court admission documents, other certifications, an image identifier of the attorney, and historical legal matter data associated with prior legal services provided to the same client associated with the virtual meeting, among other types of information. In some embodiments, a client profile may include location data associated with the client's home or work address, location data associated with particular circumstances corresponding to the legal issue, factual information associated with the circumstances corresponding to the legal issue, historical legal matter data of other legal proceedings that the client was involved in, and so forth.

FIG. 1 depicts an example operating environment 100 that includes a user device 102 having a user interface 104 capable of communicating with a legal intelligence system 106 that includes an artificial intelligence (AI) legal matter module 108, a speech to text AI module 110, a legal analyzer 112, a form generator 114, and a question generator 116. The legal intelligence system 106 is capable of communicating with one or more data stores, such as data store 120 including profile data 122, legal rules 124, training data 126, and feedback data 128.

Example operating environment 100 is but one example of a suitable environment for the technology and techniques disclosed herein and is not intended to suggest any limitation as to the scope of use or functionality of the invention. Nor should the environment 100 be interpreted as having any dependency or requirement relating to any one or combination of components illustrated. For example, other embodiments of example operating environment 100 may have additional user devices, additional data stores, and/or other network components. As another example, even though the data store 120 includes the profile data 122, legal rules 124, training data 126, and feedback data 128, a separate data store may be used for the legal rules 124.

As illustrated in example environment 100, the user device 102 is capable of communicating with a legal intelligence system 106 and the legal intelligence system 106 is capable of communicating with the data store 120. In embodiments, these systems can communicate over a network (e.g., a network providing one or more wireless communication services via wireless signals). In embodiments, the network may correspond to one or more telecommunications networks, or a portion thereof. The network might include an array of devices or components (e.g., one or more base stations). Additionally or alternatively, the network can include multiple networks, and the network can be a network of networks. In embodiments, the network or a portion thereof may be a core network, such as an evolved packet core or 5G core. Communication links between the user device 102 and the legal intelligence system 106 (and between the legal intelligence system 106 and the data store 120) may include one or more wired or wireless communication links that include a wire, a router, a switch, a transmitter, a receiver, another type of communication link component, or one or more combinations thereof.

The user interface 104 of the user device 102 enables users to communicate and interact with the legal intelligence system 106 (e.g., such that the legal intelligence system 106 can present a graphical user interface or other user interface (e.g., menu screens, selectable links, command line prompts, virtual meeting interfaces) at the user device 102. In example embodiments, the user interface 104 can include a network interface card or a wireless transceiver for facilitating communication over the network. In some embodiments, the user device 102 is the same as or similar to user device 1300, and the user interface 104 is associated with presentation components 1308, I/O ports 1310, or I/O components 1312, as described herein with respect to FIG. 13.

The legal intelligence system 106 may include one or more servers (e.g., one or more intelligent servers that use machine learning or a neural network). In addition, the one or more servers can be configured with a processing unit that is capable of: receiving, from the user device 102, legal matter data (e.g., which can be received audibly and processed via speech to text AI module 110); based on receiving the legal matter data, identifying a jurisdiction and a legal issue (e.g., using a machine learning algorithm trained using a set of textual legal documents that each include a tagged legal issue within each legal document of the set of textual legal documents); based on identifying the jurisdiction and the legal issue, analyzing a set of data, using at least one machine learning algorithm (e.g., that is trained using a set of electronic documents including particular legal rules associated with the jurisdiction and the legal issue), from at least one database (e.g., data store 120) that includes legal rules; receiving an indication of a virtual meeting (e.g., associated with a first user device associated with a client and a second user device associated with an attorney); based on analyzing the set of data and the indication of the virtual meeting associated with the legal matter data, providing (e.g., to user interface 104 of the user device 102 associated with the attorney), particular legal information for display (e.g., such as the particular legal information for display illustrated in FIGS. 10-11); determining and providing one or more questions (e.g., via question generator 116) associated with the legal issue, a particular legal rule, and the jurisdiction; retrieving and automatically populating one or more legal forms (e.g., via form generator 114) based on the legal issue, a particular legal rule, and the jurisdiction; updating one or more blocks of the legal intelligence system 106 using feedback 128; among other functionalities.

The AI legal matter module 108 of the legal intelligence system 106 may be generated by machine learning. In some embodiments, one or more of the legal intelligence system 106 and the AI legal matter module 108 may include a main processor and an auxiliary processor (e.g., a neural processing unit). For example, the auxiliary processor can control one or more states or functions corresponding to the legal intelligence system 106. In some embodiments, one or more processors associated with the AI legal matter module 108 (e.g., an image signal processor, a communication processor) may also be implemented as part of another component of the legal intelligence system 106 that is functionally related to the auxiliary processor. In some embodiments, the auxiliary processor can include a hardware structure that is specified for AI model processing.

In some embodiments, the one or more machine learning algorithms of the AI legal matter module 108 may perform learning based on the artificial intelligence being performed via a server that is separate from the AI legal matter module 108. The one or more machine learning algorithms may include, for example, supervised learning, unsupervised learning, semi-supervised learning, reinforcement learning, or one or more combinations thereof. For example, the AI legal matter module 108 may include a plurality of artificial neural network layers. An artificial neural network of the AI legal matter module 108 may be a deep neural network, a convolutional neural network, a recurrent neural network, a restricted Boltzmann machine, a deep belief network, a bidirectional recurrent deep neural network, a deep Q-network, or one or more combinations thereof. Additionally or alternatively, the AI legal matter module 108 may include a software structure other than the hardware structure.

In some embodiments, the AI legal matter module 108 can analyze a particular set of data using one or more machine learning algorithms based on legal data matter. For example, the AI legal matter module 108 can analyze a set of legal rules 124 stored in data store 120 based on an identified jurisdiction and an identified legal issue pertaining to the legal matter data. For example, a client, via user device 102, can provide legal matter data associated with receiving a legal service from an attorney. The legal matter data can include a description of an injury and a resolution being sought for the injury, for example. Continuing the example, the AI legal matter module 108, including natural language processing and machine learning, can identify a legal issue (e.g., a personal injury claim from a slip and fall injury in a store under premises liability) and jurisdiction (e.g., based on a location of the store), and analyze a set of legal rules 124, associated with legal elements for proving the premises liability claim within that jurisdiction, that are stored in data store 120.

In some embodiments, one or more training tools can be embodied in or integrated with the AI legal matter module 108. For example, in some embodiments, the training tools can be implemented in a separate computing system (such as a server, for example) that is connected to the AI legal matter module 108 across the network. In some embodiments, the AI legal matter module 108 is trained to identify the jurisdiction based on facts surrounding the legal issue provided within the legal matter data and based on profile data 122 associated with a client profile for the client. For example, the AI legal matter module 108 can be trained to understand associations between relevant facts surrounding the legal issue within the legal matter data and client profile data stored within the profile data 122 (e.g., using a training data set stored within the training data 126 having particular keywords or key phrases associated with particular facts from a plurality of fact patterns that correspond to the same legal issue). One or more models of the AI legal matter module 108 can also cluster fact patterns related to a particular legal issue (e.g., a first set of training data having a first set of fact patterns that each correspond to a first legal issue and a second set of training data having a second set of fact patterns that each correspond to a second legal issue). The legal issue clusters of fact patterns (e.g., a cluster for the duty of care of employee negligence, a cluster for negligent supervision of an employer in North Dakota) can be stored within the data store 120.

In some embodiments, a knowledge graph can be used to associate the profile data 122 with the jurisdiction or legal issue. For example, the knowledge graph can be modeled in a hierarchical structure having nodes and edges, such that the edges represent relationships between the profile data 122 and the jurisdiction or legal issue. For example, profile data 122 may include a client address, one or more addresses associated with another party involved in the legal issue, education levels of the client or the other party, employment data, prior address data, prior places of employment, prior law suits and outcomes, birth date, and other types of historical data for the client or the other party involved in the legal issue. As one non-limiting example, for a criminal legal issue, the knowledge graph can be used to associate the profile data 122 that includes a prior criminal record for the client with the criminal legal issue (e.g., association of the prior criminal record with a non-mitigating factor for a particular criminal offense). As another non-limiting example, for a premises liability legal issue, the knowledge graph can be used to associate the profile data 122 that includes a secondary home address for the client with the premises liability legal issue that occurred within the secondary home of the client.

In embodiments, the AI legal matter module 108 can identify the legal issue within the legal matter data (e.g., provided textually by the client prior to a virtual meeting associated with a legal proceeding, provided audibly by the client during the virtual meeting, provided textually by an attorney) based on applying one or more natural language understanding or other types of natural language processing techniques of the speech to text AI module 110 to the legal matter data. In some embodiments, the one or more natural language understanding or other types of natural language processing techniques can be applied via a digital assistant of the legal intelligence system 106. In some embodiments, the one or more natural language understanding or other types of natural language processing techniques can include sentence parsing (e.g., tokenizing, identifying part-of-speech tags for a sentence or phrase within the legal matter data, identifying a named entity or keyword within the legal matter data, identifying a particular dollar value amount, lemmatizing, generating dependency trees to represent the structure of the text of the legal matter data, chunk performing, etc.). In some embodiments, the AI legal matter module 108 can generate word vectors (e.g., vectors for a legal issue, vectors for a type of legal service or remedy sought, vectors associated with a party involved in the legal dispute, subtree vectors for a multi-legal issue, etc.) from words, phrases, or sentences of the legal matter data and determine distances (e.g., Euclidean distances) between vectors or between subtree vectors, for example. The AI legal matter module 108 can use the distances between these vectors to identify one or more legal issues, to identify a type of remedy sought, to identify an amount of money to be recovered or received, to identify particular legal services requested, and to further analyze the legal rules 124 in the data store 120.

In embodiments, one or more machine learning algorithms (or another component) of the AI legal matter module 108 can analyze the legal rules 124 in the data store 120 for generating particular legal information for display (e.g., during a virtual meeting between attorney and client) that includes particular legal rules that apply to the legal issue and jurisdiction associated with the legal matter data (e.g., provided by the client). In embodiments, the AI legal matter module 108 can be trained using a set of electronic documents, stored within the training data 126, which include particular legal rules or tags for the particular legal rules. For instance, the one or more machine learning models (e.g., neural networks) can be configured to receive features or vectors from the legal matter data and from the data store 120 that have been extracted or generated based on one or more of the identified legal issue, identified type of remedy sought, identified amount of money to be recovered or received, identified particular legal services requested, and identified jurisdiction.

In one non-limiting example, the legal matter data may include a description of how the client's reputation was tarnished, such that the AI legal matter module 108 identifies the legal issue as defamation and the jurisdiction as state A. Continuing this example, the AI legal matter module 108 can analyze the legal rules 124 in the data store 120, after having been trained on a dataset including electronic legal documents with tags for defamation, for the legal intelligence system 106 to generate particular legal information for display that includes a set of legal elements for defamation in state A. In aspects of this example, the legal intelligence system 106 may also use the description of how the client's reputation was tarnished to identify which of the legal elements for defamation in state A are satisfied, and which of those legal elements are unfulfilled (e.g., via the legal analyzer 112). For example, the legal matter data including the description of how the client's reputation was tarnished may include facts or images that indicate that there was a false statement being purported as a fact by the offending party, but a lack of detail to what harm was caused to the client. The legal intelligence system 106 could identify “harm” as the unfulfilled legal element based on the lack of details provided in the legal matter data.

Furthermore, the legal intelligence system 106 can provide selectable links to particular case law (e.g., identified by the legal analyzer 112) within the data store 120 that include details for the particular legal element that is unfulfilled, such that upon selection of the selectable link, the legal intelligence system 106 can display one or more case law documents that discuss that particular legal element that was not fulfilled. Furthermore, in some embodiments, the legal analyzer 112 can indicate, via a user interface display, which portion of the electronic case law document discusses the particular legal element that was not fulfilled (e.g., via annotations, highlighting, bolding, etc.). In embodiments, the legal analyzer 112 can use one or more machine learning algorithms to indicate which portion of the electronic case law document discusses the particular legal element that was not fulfilled.

Additionally or alternatively, the legal intelligence system 106 can also generate questions via question generator 116. Using the example above, based on the legal intelligence system 106 identifying “harm” as the unfulfilled legal element due to the lack of details provided in the legal matter data, the question generator 116 can provide one or more questions to a user device (of the attorney or client) to elicit more information related to the harm caused by the false statement that was purported as a fact. For example, the question generator 116 may provide the following example questions: “did you lose your job due to the false statement” or “did you lose business because of the false statement.” The question generator 116 can provide additional questions simultaneously (e.g., when there are multiple legal elements that are unfulfilled) or the question generator 116 can provide additional questions that are subsequent to the initial questions, such that the additional subsequent questions are provided in response to receiving responses (i.e. that can be used to update the legal matter data) from the client (e.g., during the virtual meeting via a user device of the attorney or client).

In some embodiments, the question generator 116 includes a probability model that utilizes a set of questions from a knowledge base within the data store 120. For example, the data store 120 may include knowledge graphs with associated questions and legal elements for each legal issue, or a table that includes a list of question and legal element pairs. In some embodiments, the question generator 116 can generate a question that conforms to a distribution of training data stored at training data 126, and in other embodiments, the question generator 116 further includes a discriminator for adversarial training. In some embodiments where there are multiple legal elements that are unfulfilled, the question generator 116 provides initial questions related to the legal element having the least amount of detail provided by the legal matter data. In some embodiments where there are multiple legal issues having one or more legal elements that are unfulfilled, the question generator 116 provides initial questions related to the legal issue having the least amount of detail provided by the legal matter data, or the legal issue having a higher damages value based on the legal matter data.

In some embodiments, the question generator 116 can be implemented as a transformer (e.g., a deep learning model or deep learning based language model). In some embodiments, the transformer has an incorporated attention mechanism (e.g., self-attention) as an additional layer for weighting word tokens of the legal matter data. For example, in some aspects of this embodiment, the word tokens corresponding to the legal issue having the higher damages value can be weighted higher than those of other legal issues. As another example, the word tokens corresponding to the legal element having the least amount of detail within the legal matter data can be weighted higher than those of other legal elements. In yet another example, word token weights can be adjusted as a virtual meeting is being conducted and as the client is speaking during the virtual meeting (i.e. based on receiving additional legal matter data associated with the legal issue or a legal element).

In some embodiments, the question generator 116 can generate questions based on a client profile for the client stored within the profile data 122. For example, a client profile can be generated using natural language processing, machine learning algorithms, semantic analysis, relation extraction and annotation analysis, entity detection, other techniques, or one or more combinations thereof, to analyze historical legal matter data associated with the client, social media data of the client, online news articles related to the client, and other types of client data to build a client profile (e.g., an ontology that is a knowledge graph with nodes and edges representing relationships between the current legal matter data and current legal issue, and relationships between the associated relevant facts and the legal issue). In some embodiments, historical location data associated with the client (e.g., having a criminal legal issue) may be collected via the user device of the client or a tracking monitor device of the client, for example, to use for building the client profile. In some embodiments, the client profile is continuously updated during a virtual meeting with the client. In one non-limiting example, the question generated for the example client above (i.e., “did you lose your job due to the false statement”) can be generated based on social media data or online news articles related to the client that discuss the client getting fired.

Form generator 114 can retrieve one or more legal forms from the data store 120. For example, the data store 120 can include a plurality of legal forms associated with particular jurisdictions and particular legal issues. In addition, the form generator 114 can also automatically populate legal forms based on the legal matter data received (e.g., initially or during the virtual meeting). In embodiments, legal forms may relate to a will and testament, a land sell or lot sell agreement, a contractor agreement, a living will, a contract, an employment agreement, an annulment, a premarital agreement, a letter of intent, an LLC formation, a confidentiality agreement, a residential or commercial lease agreement, or another type of legal form. One or more of the forms may have a particular template, and the form generator 114 can automatically populate a particular legal form based on the legal issue identified, the legal matter data provided, the profile data 122 (e.g., the client profile), additional legal matter data provided during the virtual meeting, etc.

For example, in some embodiments, the form generator 114 can automatically populate the legal form during the virtual meeting based on an audio sensor. Further, the speech to text AI module 110 can analyze received audio legal matter data using an automatic speech recognition model, for example. In embodiments, the automatic speech recognition model is trained to convert audio legal matter data into a textual output for automatic population of the legal form. For example, during the virtual meeting, the client may provide details specific for an employment agreement legal form, and the automatic speech recognition model can be trained to listen for audio responses related to particular clauses or fields within the employment agreement legal form. For instance, the automatic speech recognition model can detect keywords, such as “job duties,” to begin the automatic population of the scope of employment section of the employment agreement legal form. As another example, the automatic speech recognition model can detect audible responses that include values, such as “$50,000,” to begin the automatic population of the compensation section of the employment agreement legal form.

In embodiments, the legal intelligence system 106 can receive feedback from one of the user devices during the virtual meeting (e.g., via the user device displaying the legal form that is automatically populated) and update that legal form based on the feedback or retrieve another legal form from the data store 120 based on that feedback. For example, the feedback may indicate that the legal form is an incorrect legal form for this particular legal issue (e.g., the legal form includes clauses that are more favorable to an employee, and the client is an employer). The feedback received can be stored at feedback 128 and used to update the form generator 114. In embodiments where another legal form is retrieved, the second form can be automatically populated based on the legal issue identified, the legal matter data provided, the profile data 122 (e.g., the client profile), additional legal matter data provided during the virtual meeting, the feedback 128, etc., and provided for display at one or more user interfaces.

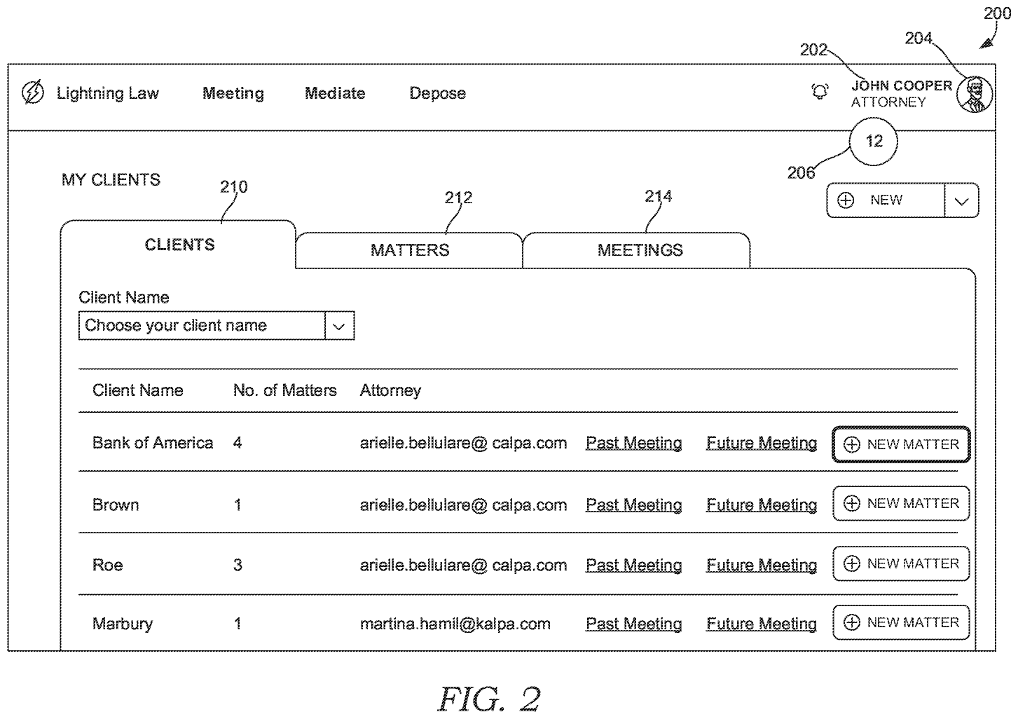

FIG. 2 provides an example user interface 200, which can be generated at least in part by utilizing the legal intelligence system 106 and the data store 120 of FIG. 1. To illustrate, in embodiments, an attorney profile can be stored within profile data 122 of FIG. 1. The attorney profile data can be used to generate at least a portion of example user interface 200. For example, the attorney profile can include a bar license number, a user identifier 202, an image identifier 204, an experiential identifier 206, other types of legal certification data, historical client data, historical virtual meeting data, scheduled virtual meeting data, other types of attorney profile data, or one or more combinations thereof.

The user identifier 202, image identifier 204, and experiential identifier 206 can be displayed on example user interface 200. For example, the user identifier 202 can identify the user as an attorney (e.g., whereas another user identifier identifies the user as a client, witness, judge, mediator, etc.). The user identifier 202 can also include a name of the user. The image identifier 204 can be an image of the attorney (or some other computer-generated image, such as an avatar of the attorney for example). The experiential identifier 206 can identify a particular expertise of the attorney. For example, the experiential identifier 206 identifies the user as having 12-years of legal experience. In other embodiments, the experiential identifier 206 may identify a particular legal practice area of the attorney (e.g., 12 years of practice in personal injury law), particular certifications for the attorney, or another type of experiential identification. Data for each of the user identifier 202, image identifier 204, and experiential identifier 206 can be stored within profile data 122 of FIG. 1 and retrieved from the data store based on receiving the indication of the virtual meeting associated with the legal matter data (or based on launching an application associated with generating a virtual meeting associated with the legal matter data, for example).

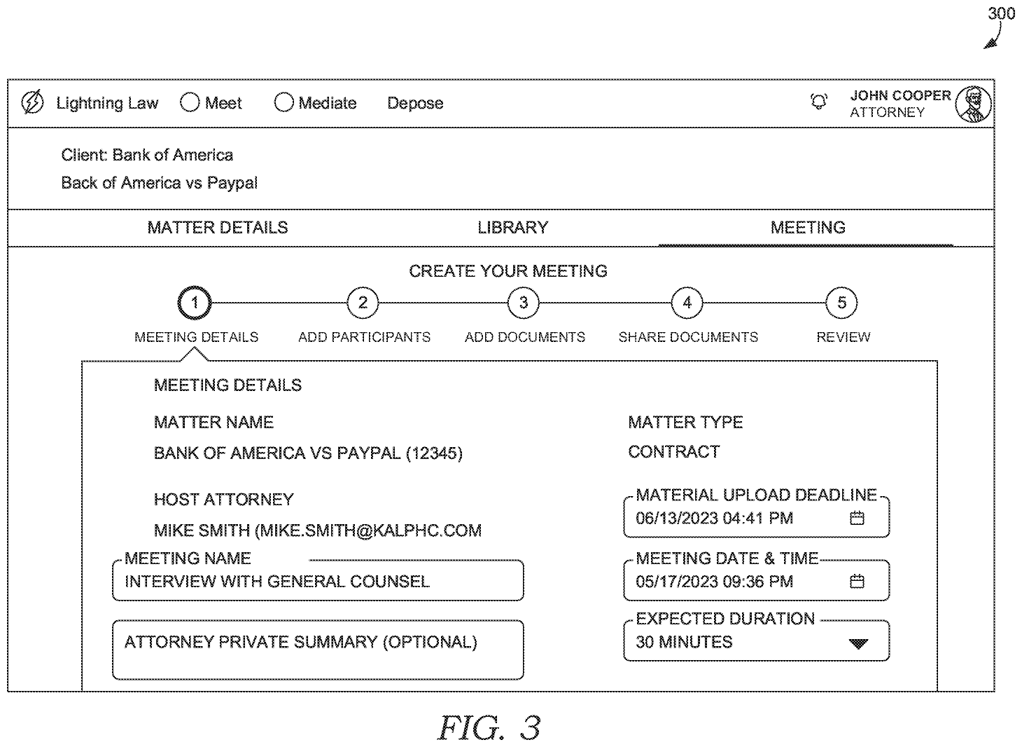

In one example embodiment, based on receiving the indication of the virtual meeting (or an indication of scheduling the virtual meeting, for example) associated with the legal matter data, attorney profile data (or data from another type of profile) from the at least one database can be retrieved for generating the example user interface 200 (or for generating at least a portion of the example user interfaces of FIGS. 3-9). For example, the attorney profile data can be generated for the attorney profile based on receiving the attorney profile data from a user device of the attorney (e.g., verbally, textually). In an example aspect of this embodiment, the at least one image identifier 204 and a participant identifier (e.g., the user identifier 202 or the experiential identifier 206) can be displayed on user devices of participants of the virtual meeting. The image identifier 204 and a participant identifier of the attorney can be associated with the bar license number of the attorney profile, and the bar license number can be determined to correspond to the jurisdiction identified from the legal matter data, such that an indication can be provided that identifies the bar license number corresponding to the jurisdiction identified. For instance, experiential identifier 206 or a second experiential identifier can indicate that the attorney is licensed to practice law within the particular the jurisdiction identified from the legal matter data.

Example user interface 200 can be provided to user devices (e.g., through an application server and application user interface) associated with an attorney or another legal proceeding participant such that the user of the user device can schedule a virtual meeting (e.g., for a mediation or deposition) based on previously stored data. For example, a user, such as an attorney, can retrieve past meeting data corresponding to historical legal matters and previously scheduled future meetings corresponding to current legal matters. Further, a user can also retrieve other historical legal matter data associated with a particular client. For example, the historical legal matter data and the current legal matter data for a first client can be merged within a dataset of the data store based on a machine learning model identifying corresponding rows or columns of datasets associated with the first client, such that a processing server can apply a database query operation on the merged dataset for the first client. Standardization can be applied to the merged dataset for the first client, such as a particular standardization to a particular data frame (e.g., a particular standardization for a legal issue column) for example.

Example user interface 200 can also provide tab 210 for the user to view particular clients that the attorney is working for, as well as selectable links that, upon selection of a “past meeting” for a particular client, will generate past meeting legal matter data for display on the user device. Additionally, example user interface 200 can also provide selectable links that, upon selection of a “future meeting” for a particular client, will generate future meeting legal matter data for display on the user device. Furthermore, new matters can be generated for adding additional legal matter data for a new matter for storage into the data store via the example user interface 200 through the client tab 210. In addition, the example user interface 200 also provides a matters tab 212 for a different user interface feature and a meetings tab 214 for another user interface feature, such that the user can access the data within the data store in a different user interface display arrangement.

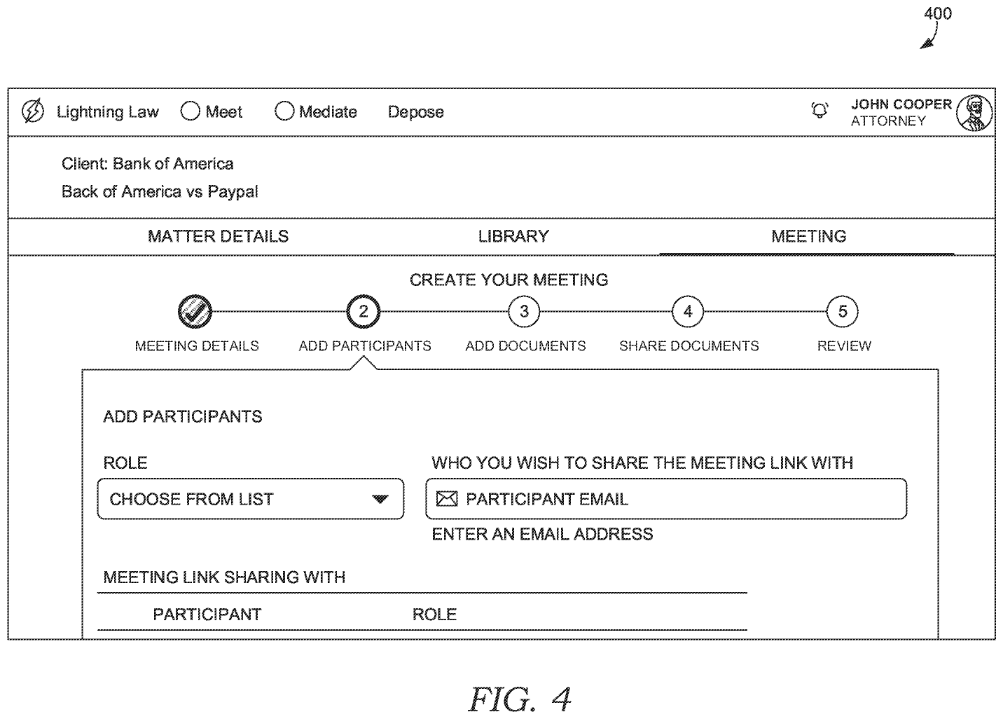

FIG. 3 provides example user interface 300, which can be generated at least in part by utilizing the legal intelligence system 106 and the data store 120 of FIG. 1. User interface 300 can be used for generating a virtual meeting between participants of a legal proceeding. In some embodiments, the indication of the virtual meeting associated with the legal matter data can be received based on a participant of the legal proceeding providing one or more virtual meeting details (e.g., a matter number, a matter name, a client name, an email address of a participant, a private summary, an upload deadline, a date, a time, an expected duration). In another example embodiment, the indication of the virtual meeting associated with the legal matter data can be received based on a participant of the legal proceeding providing one or more participant details (e.g., a role of a participant, an email address of a participant, an indication of who to share a particular uploaded document with), as illustrated in example user interface 400 of FIG. 4.

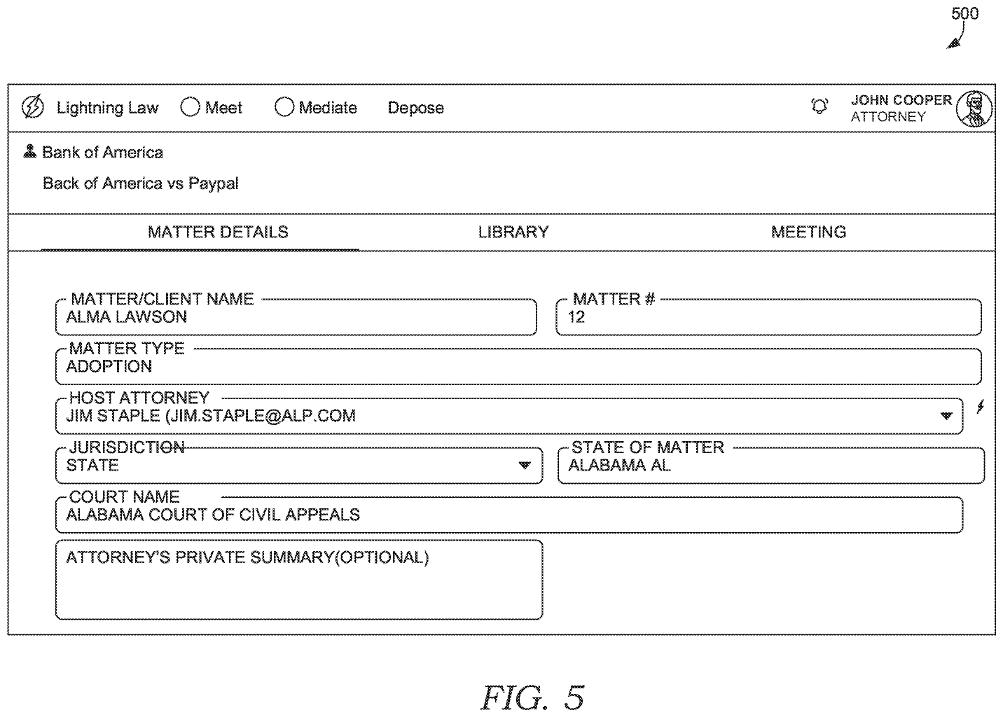

Example user interface 500 of FIG. 5 includes example legal matter data that can be used for generating the virtual meeting for the participants of a legal proceeding or for generating or updating a profile (e.g., associated with profile data 122 of FIG. 1, such as an attorney profile or client profile for example). In some embodiments, the example legal matter data of user interface 500 can be used to automatically populate a legal form (e.g., via form generator 114 of FIG. 1), identify a jurisdiction (or legal issue, a legal remedy sought, or a particular legal service requested by a client, for example), generate questions (e.g., via question generator 116 of FIG. 1), and analyzing a set of data, using at least one machine learning algorithm, from at least one database that includes legal rules for generating particular legal information for display (e.g., via the legal intelligence system 106 of FIG. 1), etc. As illustrated in example user interface 500, the legal matter data can include a client name, a matter number, a matter type, a host attorney, a state corresponding to the jurisdiction, a court name associated with the jurisdiction, and summary details provided by an attorney user.

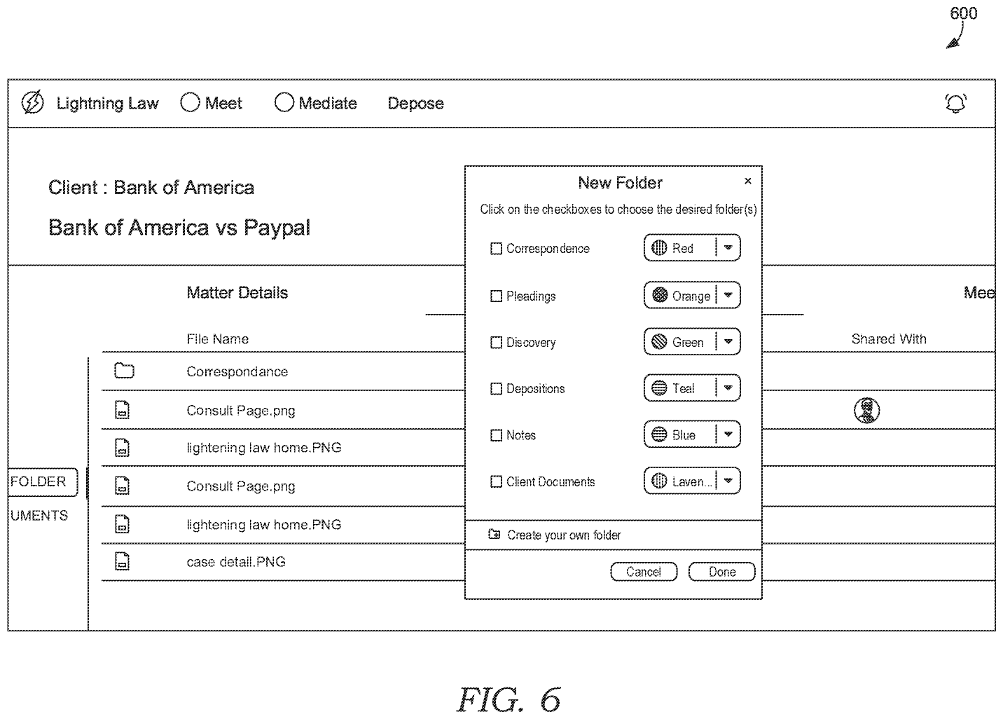

FIG. 6 provides an example user interface 600 for customized coding of folders (or particular electronic legal documents uploaded for a particular virtual meeting, for example) for different types of legal matter data associated with a particular client or associated with a particular virtual meeting that includes a particular client. For example, each of the customizations to the folders can be based on a particular legal proceeding in which the legal matter data for a particular client or matter corresponds. In some embodiments, a legal form can be automatically populated (e.g., via form generator 114 of FIG. 1) based on a particular customization of a folder or based on a particular customization to an uploaded electronic document associated with the legal matter data. In some embodiments, the set of data that includes legal rules can be analyzed using at least one machine learning algorithm (for generating particular legal information for display) based on the particular customizations of folders or particular customizations to uploaded electronic documents associated with the legal matter data. In some embodiments, particular questions can be generated (e.g., via question generator 116 of FIG. 1) during a virtual meeting based on the particular customizations of folders or uploaded electronic documents associated with the legal matter data.

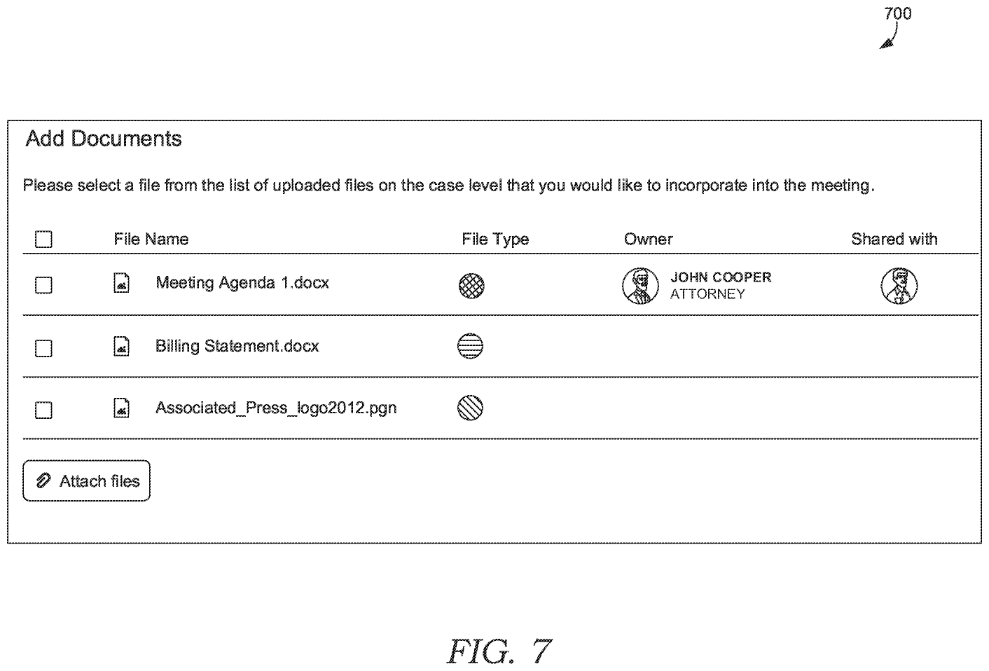

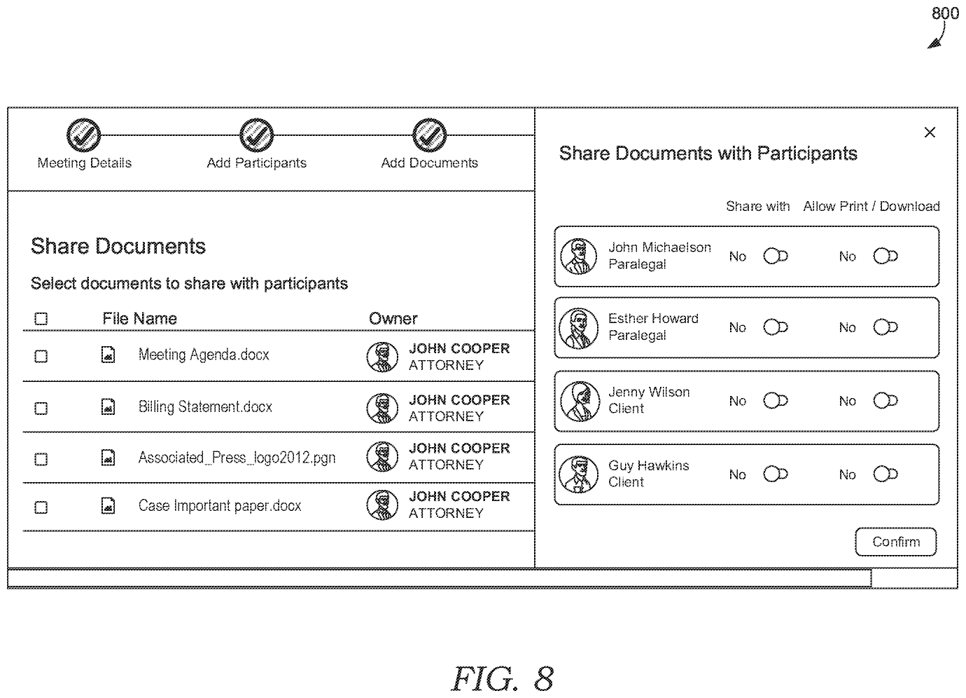

FIGS. 7-8 provide an example user interface 700 for uploading the customized electronic legal documents for a virtual meeting (e.g., to share with one or more other participants of a legal proceeding virtual meeting), and an example user interface 800 for sharing the electronic documents with other participants. In some embodiments, particular questions can be generated (e.g., via question generator 116 of FIG. 1) during a virtual meeting based on whom the electronic legal documents are to be shared. For example, the question can be generated based on identifying an associated profile (e.g., a paralegal profile, a client profile) for the user in which the electronic legal documents are shared. Similarly, in some embodiments, a legal form can be automatically populated (e.g., via form generator 114 of FIG. 1) based on whom the electronic legal documents are shared.

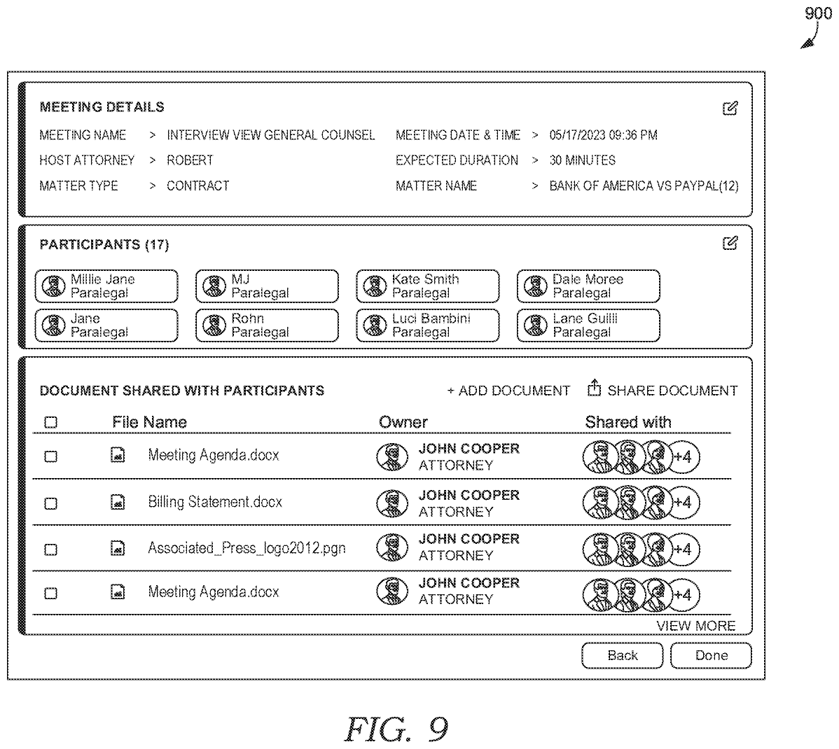

FIG. 9 provides an example user interface 900, which includes legal matter data for a virtual meeting (e.g., a meeting name, host attorney, meeting date and time, expected duration of the virtual meeting, matter name, and matter type). For example, in some embodiments, the particular questions can be generated (e.g., via question generator 116 of FIG. 1) during a virtual meeting based on determining that the virtual meeting is an internal meeting (e.g., based on the virtual meeting including only attorney and paralegal participants of the same entity or organization) or based on with whom a particular electronic legal document or previously automatically populated form was shared. For instance, particular legal information can be displayed based on a user interface, wherein the particular legal information includes the example embodiment of particular legal information 1000 of FIG. 10 or the example embodiment of particular legal information 1100 of FIG. 11.

To illustrate, the particular legal information 1000 includes a first set of particular legal elements (e.g., “(1) it must be in writing; (2) it must bear the testator's signature or be signed in the testator's name; and (3) it must also bear the signatures of at least two persons who witnessed either the testator's signature or the testator's acknowledgment of the signature”) associated with a particular legal issue (e.g., establishing a will). The particular legal information 1000 also includes cited relevant case law associated with a particular jurisdiction (e.g., In re Estate of Royal, 826 P.2d, 1236 (Colo. 1992)). Further, the particular legal elements of the particular legal issues (e.g., the legal issue of establishing a will, undue influence, and testamentary capacity) are displayed in bold font. In other embodiments, the particular legal elements of the particular legal issues (e.g., the legal issue of establishing a will, undue influence, and testamentary capacity) can be displayed in different color fonts.

In some embodiments, based on analyzing particular stored electronic legal documents associated with the jurisdiction of a particular legal issue and the legal matter data, particular legal elements can be determined as satisfied or unfulfilled and displayed as the particular legal information 1100. For example, the particular legal information 1100 may include at least one legal rule indicated as unfulfilled (e.g., for the legal issue of testamentary capacity, legal elements (1), (3), (4), and (5) of the particular legal information 1100 include a “no” marker). As another example, the particular legal information 1100 may include at least one legal rule indicated as satisfied (e.g., for the legal issue of establishing a valid will, legal elements (1)-(3) of the particular legal information 1100 include a “yes” marker). In some embodiments, the particular legal information 1100 may include a warning indicator (e.g., based on analyzing prior case law, a determination can be made that a particular legal factor associated with a particular legal issue is often in dispute or that the particular legal factor is a particular exception to a particular legal rule).

### Example Flowchart for Utilizing the Legal Intelligence System

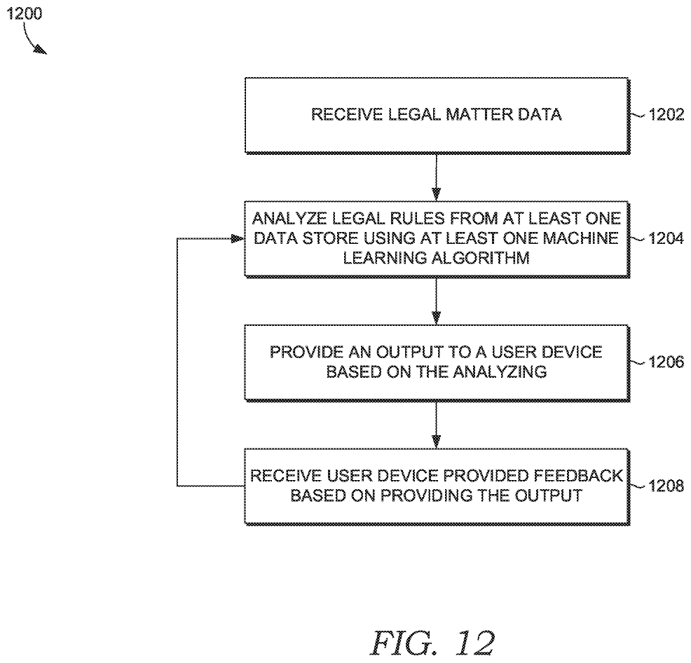

Having described the example embodiments discussed above of the presently disclosed technology, an example flowchart is described below with respect to FIG. 12. Although the term “step” may be used herein to connote different elements of methods employed, this term should not be interpreted as implying any particular order among or between various steps herein disclosed unless and except when the order of individual steps is explicitly described.

For example, FIG. 12 begins at step 1202 with receiving legal matter data. In embodiments, legal matter data may be received from a user device. In embodiments, legal matter data may be a textual input provided by an attorney, client, potential client, or another entity involved in a particular legal proceeding. The legal matter data may, in some embodiments, be received via an audio sensor. An audio sensor may be an acoustic device or another mechanism capable of sensing or otherwise detecting a soundwave. For example, an audio sensor may comprise a microphone capable of sensing or otherwise determining an audio response generated from the audio source. As another example, an audio source may comprise one or more woofers, tweeters, speakers, or another acoustic devices or mechanisms configured for emitting sound waves. In such examples, an audio sensor may comprise a plurality of microphones that are each configured to sense the audio response substantially simultaneously. As another example, an audio sensor may comprise an array of microphones configured to sense or otherwise determine the audio response generated by the audio source.

In embodiments wherein the legal matter data is received via the audio sensor, the audio legal matter data can be analyzed by an automatic speech recognition model. For example, the automatic speech recognition model may be a speech recognition model capable of recognizing a user's speech. Further, the automatic speech recognition model may be trained to convert an audio response received from the user (e.g., during a virtual meeting) into a textual output. In some embodiments, the automatic speech recognition model may be an artificial intelligence model that includes, for example, a sound model, a pronunciation dictionary, a language model, another type of model, or one or more combinations thereof. In yet another example, the automatic speech recognition model may be, in some embodiments, an end-to-end speech recognition model that has an integrated neural network (e.g., without separately including the sound model, the pronunciation dictionary, or the language model). For example, the end-to-end speech recognition model may use the integrated neural network to convert the speech signal into text without the conversion of a phoneme (i.e. distinct units of sound in a specified language that distinguish one word from another, for example “p,” “b,” “d,” and “t” in the English words pad, pat, bad, and bat) into text after recognizing the phoneme from the audio response. In some embodiments, the automatic speech recognition model includes a Recurrent Neural Network Transducer model and a connectionist temporal classification model. In other embodiments, the legal matter data that is received via the audio sensor can be transformed into textual output using a trained integrated deep neural network.

The legal matter data can correspond to a client or potential client. For example, the legal matter data may be associated with particular information that is (or that can be) relevant to a particular legal issue associated with the client or potential client. For instance, in a breach of contract legal issue associated with a particular state, the legal matter data may include information related to performance of a contractual term. As another example, in a criminal legal issue associated with a particular state, the legal matter data may include information related to mitigating circumstances (e.g., “I've never been in trouble with the police before”). In embodiments, legal matter data can include factual data, contract data (e.g., contractual terms, an image of the contract itself), regulation data, other types of legal matter data (e.g., an image of a license plate, a video of a battery or assault), or one or more combinations thereof. In some embodiments, the legal matter data, or a portion thereof, may correspond to particular information that is attorney-client privileged.

At step 1204, legal rules stored in at least one data store are analyzed using at least one machine learning algorithm. In some embodiments, the at least one machine learning algorithm analyzes the legal rules based on an identified jurisdiction and an identified legal issue from the legal matter data. For example, another machine learning algorithm can be used to identify the jurisdiction, the legal issue, or one or more combinations thereof, wherein the other machine learning algorithm is trained using textual electronic legal documents that include tagged legal issues within the textual electronic legal documents. To illustrate, the legal issues within the textual electronic legal documents can be tagged based on a type of law (e.g., contract law, tort law) or a particular keyword or phrase (e.g., “hit me,” “the contract,” “the police”). In some embodiments, the other machine learning algorithm is trained using previously-generated client engagement forms each having at least one tagged legal issue. As another example, in some embodiments, a training dataset including tagged legal issues can include a first dataset associated with a particular type of tort law (e.g., defects in marketing under product liability in tort law) and a second dataset associated with another particular type of tort law (e.g., manufacturing defects under product liability in tort law).

As one non-limiting example, the legal issue could also be identified based on an image of an employment agreement uploaded during a virtual meeting or stored within a profile. For example, the legal issue could be determined by applying an optical character recognition technique (e.g., that employs machine learning algorithms) to the image of the employment agreement to identify a particular clause within the employment agreement that corresponds to a particular keyword extracted from a legal matter description. As another example, the machine learning algorithm that identifies the particular clause can be trained using a training dataset that includes tagged employment agreement clauses within electronic legal documents.

In some embodiments, the jurisdiction can be identified based on location data within the legal matter data. In other embodiments, the jurisdiction can be identified based on both location data and factual data within the legal matter data (e.g., a jurisdiction of a particular court based on a particular geographical area in which the circumstances associated with the legal issue arose). Some techniques for identifying the jurisdiction may include, for example, natural language processing, machine learning, relation extraction and annotation analysis, semantic analysis, entity detection, and so forth. For instance, the legal matter data (e.g., associated with the location data and factual data) can be applied to a knowledge graph having nodes and edges that represent factual data and relationships with a particular jurisdiction. In some embodiments, the knowledge graph can be updated based on feedback provided by an attorney after reviewing the legal matter data and identified jurisdiction. In some embodiments, the knowledge graph can be continuously updated after each identification of a particular jurisdiction for each legal matter data entry.

In some embodiments, the jurisdiction can be identified based on a client profile. For example, a client profile for a client (e.g., another lawyer who is a client, a client who is not a lawyer) may include location data associated with the client (e.g., a home address of the client, a work address of the client, a second home address of the client, an address associated with the signing of a particular legal document or a particular performance associated with the document, GPS location data continuously received from a device associated with the client, etc.), the legal matter data, historical client data associated with historical legal matter data (e.g., historical legal matter data for a previous legal service provided to the client), or other types of client profile data. In embodiments wherein the client is an attorney, the client profile may also include one or more bar license numbers, jurisdictions and courts in which the client is admitted to practice law, other legal certification data, entities that the client has represented, other information related to the client's practice of the law, or one or more combinations thereof. In some embodiments, the client profile includes at least one image identifier (e.g., similar to the image identifier of FIG. 2) associated with the client.

As one non-limiting example, the jurisdiction could be identified based on an image of a contract stored within the client profile and the legal issue (e.g., determined by applying a machine learning algorithm, trained using textual electronic legal documents that include tagged legal issues within the textual electronic legal documents, to the legal matter data) being a breach of the contract. For example, an optical character recognition technique that employs machine learning algorithms can be applied to an image of a contract to identify the jurisdiction identified within the contract. In another non-limiting example, the jurisdiction could be identified based on an arbitration location associated with the legal matter data and stored within the client profile, and based on the arbitration location's association with the legal matter data. In some embodiments, the jurisdiction can be identified based on historical legal matter data associated with the current legal matter data.

In some embodiments, based on identifying the legal issue or the jurisdiction, one or more machine learning algorithms are used to analyze legal rules stored in at least one data store (e.g., for generating particular legal information relevant to the legal matter data and legal issue for display, for automatically populating a legal form, or for generating one or more questions that should be answered based on the legal matter data received). For example, the legal rules can be analyzed such that the machine learning algorithm is used to identify one or more particular legal rules that correspond to the jurisdiction and legal issue. In one non-limiting example, the jurisdiction could be the Southern District of New York, the legal issue could be tortuous battery, and the particular legal rule corresponding to tortuous battery in the Southern District of New York could include “an intentional unwanted touching.”

In some embodiments, the one or more machine learning algorithms, used to analyze the legal rules stored in the at least one data store, can be trained using a set of electronic legal documents that each include at least one particular legal rule. For example, training datasets can be used to train the one or more machine learning algorithms, wherein the datasets of the electronic legal documents include tagged legal rules. In embodiments, training datasets can be tagged based on both jurisdiction and characteristics of the legal rule. For example, a first training dataset for a first jurisdiction (e.g., a federal jurisdiction) can be tagged for a first set of legal elements (e.g., the legal elements for trademark infringement under the Lanham Act) and a second training dataset for the first jurisdiction can be tagged for a first set of factors associated with the first set of legal elements (e.g., the Lapp test that includes factors to be considered for determining an element of the Lanham Act). In embodiments, the training of the one or more machine learning algorithms, for analyzing the legal rules stored in the at least one data store, can be performed by one or more engines or classifiers that are supervised, unsupervised, or a hybrid including aspects of both supervised and unsupervised learning.

At step 1206, particular legal information can be provided for display via a user interface of a user device based on output from the one or more machine learning models analyzing the electronic legal documents that include legal rules. In some embodiments, the particular legal information can be the particular legal information displayed in FIGS. 10-11, or similar to the particular legal information displayed in FIGS. 10-11. In some embodiments, the particular legal information is displayed to a user device corresponding to an attorney, a user device corresponding to a client, another particular user device associated with a particular virtual meeting, or one or more combinations thereof. In some embodiments, the particular legal information is displayed to a user device corresponding to an attorney based on an indication of a virtual meeting associated with the legal matter data and before the virtual meeting begins.

In some embodiments, the particular legal information includes a particular set of legal rules corresponding to the jurisdiction and the legal issue, and also includes at least one legal rule indicated as either satisfied or unfulfilled. For example, the particular legal issue may be whether a will was valid in New Jersey, the particular legal information provided may include “two people witnessed the testator sign the will or witnessed the testator acknowledge the signature or will itself” and “testator must be of sound mind.” Continuing this example, the particular legal information may include an indication that the witness legal rule has been satisfied (e.g., by providing a checkmark and a selectable link to the legal matter data supporting this determination), and the particular legal information may include an indication that the mental state rule has been unfulfilled (e.g., by highlighting that particular legal rule and providing a selectable link to the legal matter data supporting this determination). In some embodiments, the particular legal information displayed on the user interface (e.g., of a user device corresponding to the attorney) may include another selectable link associated with a particular electronic document, such as case law from New Jersey that provides details for determining the mental state of the testator. In addition, the particular legal information displayed can include a plurality of selectable links that provide further resources for the attorney to make a determination as to whether the testator had a sound mind (e.g., selectable links to recent New Jersey case law having a particular decision date threshold, selectable links to secondary references including treatises that discuss mental state of the testator in New Jersey case law, recent legal news articles discussing a recent decision on mental state of a testator in New Jersey, etc.).

In some embodiments, based on analyzing the legal rules using the machine learning algorithm to identify particular legal rules that correspond to the jurisdiction and legal issue, and based on an indication of a virtual meeting of participants associated with the legal matter data, one or more questions associated with the legal issue and identified legal rules can be generated and displayed (e.g., to the user device of the attorney before, during, or after the virtual meeting). For example, a first question may be displayed during the virtual meeting (e.g., including an attorney and a client) associated with the legal matter data, a first user device (e.g., of the client), and a second user device (e.g., of the attorney). In some embodiments, the first question may be displayed on the second user device or both user devices during the virtual meeting. In some embodiments, a second question can be generated and displayed based on the client verbally answering the question during the virtual meeting.

In some embodiments, the questions associated with the legal issue and identified legal rules can be generated using a deep learning system that learns to generate these questions through reinforcement learning (e.g., using a generative adversarial network). For example, the deep learning system can expand a search within the data store that stores the electronic legal documents including the legal rules using a graph generated by parsing legal matter data and extracting phrases or keywords from the legal matter data. The graph can be generated from a knowledge graph associated with the data store, such that the graph corresponding to the particular legal matter data incorporates similar properties of the knowledge graph and is also contextualized in accordance with the particular legal matter data. In some embodiments, different knowledge graphs are used based on the particular field of law associated with the legal matter data (e.g., copyright law, product liability law) for domain-specific knowledge in the context of a particular legal field.

In some embodiments, the questions associated with the legal issue and identified legal rules can be generated using a generative adversarial reinforcement learning network that uses the expanded search within the data store and retrieved legal rules from the data store. In embodiments, the generative adversarial reinforcement learning network can include a neural generative language model, a neural evaluator language model, another type of model, or one or more combinations thereof. In some embodiments, one or more keywords within the legal matter data and the expanded search generated from the legal matter data are weighted more heavily (e.g., a keyword from the expanded search “battery” can be weighted more heavily than “hit me” from the legal matter data). Example questions that may be generated using the deep learning or reinforcement learning and that correspond to the legal issue and legal rules may include questions that illicit further detail from the client based on identified legal rules that are unfulfilled. In one non-limiting example, for the validity of will legal issue, the question may relate to whether the testator had any ailments at the time of execution of the will.

In some embodiments, based on providing a first question for display to the user interface of the user device (e.g., to the user device of the attorney or client during the virtual meeting), an audio response can be received from the user device of the client during the virtual meeting, and this audio response can be used to update the particular legal information displayed (e.g., displayed to the attorney during the virtual meeting), to update the legal matter data stored at the data store, to automatically populate a legal form associated with the legal matter data and virtual meeting, or to generate a second question for display (e.g., during the virtual meeting). For example, another legal rule, that has not been satisfied, can be identified based on the audio response and the legal matter data received from the client. In one non-limiting example, a client who obtained an injury while skiing at a ski resort may initially be asked whether she still has her ticket. Upon the client responding “yes” during the virtual meeting, the second question may include asking the client if she can upload images of the ticket or hold up the ticket during the virtual meeting. In this way, based on analyzing the set of data and receiving responses from the client during the virtual meeting, additional legal rules can be identified and additional questions can be generated based on the responses from the client and the additional legal rules that have not yet been satisfied based on each of the client's responses. Stated differently, based on analyzing the set of data at step 1206 and based on receiving the client responses at step 1208, additional legal rules can be identified and additional questions can be generated.

In some embodiments, based on identifying the jurisdiction and the legal issue and based on analyzing the set of data, one or more legal forms from the at least one database can be retrieved. For example, one or more data stores can include a plurality of legal forms associated with the jurisdiction and the legal issue. In embodiments, a rule-based model or neural network model can be used to analyze legal matter data or audio responses during the virtual meeting to automatically populate a particular legal form having a particular template. In some embodiments, the model can analyze the legal matter data or audio responses based on speech tags embedded as part of one or more sentences that may be audibly generated during the virtual meeting. In some embodiments, the one or more data stores include tags or tag metadata (e.g., for keywords, phrases, dates, locations) for associating particular legal matter data or audio responses with a particular video conference participant, a particular legal rule, etc. In some embodiments, the model can be trained using textual legal forms that include tagged legal issues within the textual legal forms. For example, the tagged legal forms may also include particular legal elements to be satisfied for a particular legal issue that are also tagged by element. As another example, keywords within each legal element may also be tagged.

In some embodiments, the model can analyze the legal matter data or audio responses based on a client profile, an attorney profile, or another type of profile stored within the one or more data stores. In some embodiments, the one or more legal forms can be automatically populated based on a structured outline of input fields for a particular legal form. In some embodiments, the particular legal form can be selected based on a document uploaded by the client that is relevant to the legal issue, based on virtual meeting data entered by the attorney, information provided by the client through an intake form or during the virtual meeting, or one or more combinations thereof.

In some embodiments, based on providing a first legal form that is automatically populated for display on the user interface (e.g., to the attorney during a virtual meeting), textual feedback can be received from a user associated with the user interface displaying the first legal form that is automatically populated. For example, the attorney or client can provide feedback indicating that another legal form should be used instead, or the attorney could adjust or reenter particular information within a field of the first legal form. Based on receiving the textual feedback, a second legal form from the data store can be retrieved and provided for display (and automatically populated as well), or the feedback provided by the user can be stored within the data store and the rule-based model or neural network model can be updated based on this feedback. Stated differently, based on analyzing the set of data at step 1206 and based on receiving the legal form feedback from the user at step 1208, additional legal forms can be identified and additional legal forms can be generated.

### Example User Device

An example operating environment of an example user device (e.g., user device 102 of FIG. 1) is described below with respect to FIG. 13. User device 1300 is but one example of a suitable computing environment, and is not intended to suggest any particular limitation as to the scope of use or functionality of the technology disclosed. Neither should user device 1300 be interpreted as having any dependency or requirement relating to any particular component illustrated, or a particular combination of the components illustrated in FIG. 13.

As illustrated in FIG. 13, example user device 1300 includes a bus 1302 that directly or indirectly couples the following devices: memory 1304, one or more processors 1306, one or more presentation components 1308, one or more input/output (I/O) ports 1310, one or more I/O components 1312, a power supply 1314, and one or more radios 1316.

Bus 1302 represents what may be one or more busses (such as an address bus, data bus, or combination thereof). Although the various blocks of FIG. 13 are shown with lines for the sake of clarity, in reality, these blocks represent logical, not necessarily actual, components. For example, one may consider a presentation component, such as a display device, to be an I/O component. Also, processors have memory. Accordingly, FIG. 13 is merely illustrative of an exemplary user device that can be used in connection with one or more embodiments of the technology disclosed herein.

User device 1300 can include a variety of computer-readable media. Computer-readable media can be any available media that can be accessed by user device 1300 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 1300. Computer storage media does not comprise signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 1304 includes computer storage media in the form of volatile and/or nonvolatile memory. The memory 1304 may be removable, non-removable, or a combination thereof. Example hardware devices of memory 1304 may include solid-state memory, hard drives, optical-disc drives, other hardware, or one or more combinations thereof. As indicated above, the computer storage media of the memory 1304 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 1300, or one or more combinations thereof.

The one or more processors 1306 of user device 1300 can read data from various entities, such as the memory 1304 or the I/O component(s) 1312. The one or more processors 1306 may execute, for example, software to control one or more components of the user device 1300. In addition, the one or more processors 1306 can execute instructions, for example, of an operating system of the user device 1300 or of one or more suitable applications. Further, the one or more processors 1306 may include, for example, one or more microprocessors, one or more CPUs, a digital signal processor, one or more cores, a host processor, a controller, a chip, a microchip, one or more circuits, a logic unit, an integrated circuit, an application-specific integrated circuit, any other suitable multi-purpose or specific processor or controller, or one or more combinations thereof. In some embodiments, the one or more processors 1306 may include a main processor (e.g., a central processing unit, an application processor), an auxiliary processor (e.g., a graphics processing unit, an image signal processor, a sensor hub processor, a communication processor) that is operable independently from, or in conjunction with, the main processor, another type of processor, or one or more combinations thereof. Additionally or alternatively, the auxiliary processor may be adapted to consume less power than the main processor. In some embodiments, the auxiliary processor may be specific to a specified function. In some embodiments, the auxiliary processor may be implemented as separate from, or as part of the main processor.

The one or more presentation components 1308 can present data indications via user device 1300, another user device, or a combination thereof. Example presentation components 1308 may include a display device (e.g., adapted to detect a touch), speaker, a hologram component, a printing component, sensor circuitry (e.g., a pressure sensor capable of measuring an intensity of force incurred by a touch), a vibrating component, a projector and control circuitry, another type of presentation component, or one or more combinations thereof. In some embodiments, the one or more presentation components 1308 may comprise one or more applications or services on a user device, across a plurality of user devices, or in the cloud. The one or more presentation components 1308 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof.

The one or more I/O ports 1310 allow user device 1300 to be logically coupled to other devices, including the one or more I/O components 1312, some of which may be built in. Example I/O components 1312 can include a microphone, joystick, game pad, satellite dish, scanner, printer, wireless device, and the like. The one or more I/O components 1312 may, for example, provide a natural user interface that processes air gestures, voice, or other physiological inputs generated by a user. In some instances, the inputs the user generates may be transmitted to an appropriate network element for further processing. A natural user interface may implement any combination of speech recognition, touch and stylus recognition, facial recognition, biometric recognition, gesture recognition both on screen and adjacent to the screen, air gestures, head and eye tracking, and touch recognition associated with the one or more presentation components 1308 on the user device 1300.

In some embodiments, the user device 1300 may be equipped with one or more depth cameras, one or more stereoscopic cameras, one or more infrared cameras, one or more RGB cameras, another type of image generating device (e.g., for gesture detection and recognition), or one or more combinations thereof. Additionally, the user device 1300 may, additionally or alternatively, be equipped with one or more accelerometers, gyroscopes, magnetometers, cameras, capacitance sensors, proximity sensors (e.g., an infrared proximity sensor or a capacitive proximity sensor), an atmospheric pressure sensor, a gesture sensor, a grip sensor, a color sensor, an illuminance sensor, a humidity sensor, another type of sensor, or one or more combinations thereof. In some embodiments, the output of the motion or orientation sensors may be provided to the one or more presentation components 1308 of the user device 1300 to render immersive augmented reality, virtual reality, another type of extended reality, or one or more combinations thereof.

The power supply 1314 of user device 1300 may be implemented as one or more batteries or another power source for providing power to components of the user device 1300. In embodiments, the power supply 1314 can include an external power supply, such as an AC adapter or a powered docking cradle that supplements or recharges the one or more batteries. In aspects, the external power supply can override one or more batteries or another type of power source located within the user device 1300.

Some embodiments of user device 1300 may include one or more radios 1316 (or similar wireless communication components). The one or more radios 1316 can transmit, receive, or both transmit and receive signals for wireless communications. In embodiments, the user device 1300 may be a wireless terminal adapted to receive communications and media over various wireless networks. User device 1300 may communicate using the one or more radios 1316 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 802.16 protocols), or one or more combinations thereof. In some embodiments, the one or more radios 1316 may facilitate communication via radio frequency signals, frames, blocks, transmission streams, packets, messages, data items, data, another type of wireless communication, or one or more combinations thereof.

The one or more radios 1316 may be capable of transmitting, receiving, or both transmitting and receiving wireless communications via mm waves, FD-MIMO, massive MIMO, 3G, 4G, 5G, 6G, another type of Generation, 802.11 protocols and techniques, another type of wireless communication, or one or more combinations thereof. For example, the one or more radios 1316 may be capable of handling wireless communications in frequency ranges such as a low-band communication from 600 to 960 MHz, a mid-band communication from 1710 to 2170 MHz, a high band communication from 2300 to 2700 MHZ, an ultra-high band communication from 3400 to 3700 MHZ, another communication band between 600 MHz and 4000 MHz, another suitable frequency, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system comprising:
one or more processors; and
computer memory storing computer-usable instructions that, when executed by the one or more processors, cause the system to perform operations comprising:
receiving, from a user device, matter data;
based on receiving the matter data, identifying an issue;
based on identifying the issue, analyzing a set of data, using at least one machine learning algorithm, from at least one database that includes rules;
receiving an indication of a virtual meeting associated with the matter data; and
based on analyzing the set of data and the indication of the virtual meeting associated with the matter data, providing, to a user interface, particular information for display.

2. The system according to claim 1, wherein the matter data is legal matter data, wherein the issue is a legal issue, wherein the operations further include identifying a jurisdiction based on receiving the legal matter data, wherein the set of data is analyzed using the at least one machine learning algorithm further based on identifying the jurisdiction and the legal issue, and wherein the particular information provided for display is based on the indication of the virtual meeting associated with the legal matter data.

3. The system according to claim 2, the operations further comprising:
identifying the jurisdiction and the legal issue using a second machine learning algorithm trained using textual legal documents that include tagged legal issues within the textual legal documents;
based on analyzing the set of data, determining a first question associated with the legal issue; and
providing, to the user interface, the first question for display.

4. The system according to claim 3, the operations further comprising:
based on identifying the jurisdiction and the legal issue and based on analyzing the set of data, retrieving a first legal form from the at least one database, wherein the at least one database includes a plurality of legal forms associated with the jurisdiction;
automatically populating the first legal form based on the legal matter data received;
providing the first legal form that is automatically populated for display on the user interface;
receiving textual feedback from a user associated with the user interface displaying the first legal form that is automatically populated; and
based on receiving the textual feedback, retrieving a second legal form from the at least one database.

5. The system according to claim 4, the operations further comprising:
based on retrieving the second legal form, automatically populating the second legal form based on the legal matter data received and the textual feedback; and
providing the second legal form that is automatically populated for display on the user interface.

6. The system according to claim 5, wherein the second legal form is retrieved using a third machine learning algorithm trained using textual legal forms that include tagged legal issues within the textual legal forms.

7. The system according to claim 2, the operations further comprising:
based on receiving the indication of the virtual meeting associated with the legal matter data, retrieving, from the at least one database, an attorney profile including a bar license number and at least one image identifier, the attorney profile associated with the user interface displaying the particular legal information;
receiving another indication that the virtual meeting associated with the legal matter data has begun, the virtual meeting corresponding to the user device in which the legal matter data was received and a second user device having the user interface; and
providing the at least one image identifier and a participant identifier associated with the bar license number for display via the user device and the second user device during the virtual meeting.

8. The system according to claim 7, wherein the particular legal information includes a particular set of legal rules corresponding to the jurisdiction and the legal issue, and wherein the particular legal information includes at least one legal rule indicated as unfulfilled.

9. A method comprising:
receiving, from a first user device associated with a legal client, legal matter data;
based on receiving the legal matter data, analyzing the legal matter data to identify a jurisdiction and a legal issue;
based on the jurisdiction and the legal issue identified, analyzing a set of data, using at least one machine learning algorithm, from at least one database that includes legal rules, wherein the at least one machine learning algorithm is trained using a set of electronic documents including particular legal rules associated with the jurisdiction and the legal issue;
receiving an indication of a virtual meeting associated with the first user device and a second user device associated with an attorney; and
based on analyzing the set of data and the indication of the virtual meeting associated with the legal matter data, providing, to a user interface of the second user device, particular legal information for display.

10. The method according to claim 9, wherein the particular legal information displayed on the user interface of the second user device includes a selectable link associated with a particular electronic document.

11. The method according to claim 10, further comprising providing the particular electronic document for display via the second user device upon receiving a selection of the selectable link.

12. The method according to claim 9, further comprising:
identifying the jurisdiction and the legal issue using a second machine learning algorithm trained using a set of textual legal documents that each include a tagged legal issue within each legal document of the set of textual legal documents;
based on analyzing the set of data, determining a first question associated with the legal issue and at least one legal rule corresponding to the legal issue and the jurisdiction; and
providing, to the user interface, the first question for display during the virtual meeting associated with the legal matter data, the first user device, and the second user device.

13. The method according to claim 12, further comprising:
identifying, using the second machine learning algorithm, a second legal issue based on the legal matter data received;
based on identifying the second legal issue, analyzing a second set of data, using the at least one machine learning algorithm, from the at least one database;
based on analyzing the second set of data, determining a second question associated with the second legal issue and at least one legal rule corresponding to the second legal issue and the jurisdiction; and
providing, to the user interface, the second question for display during the virtual meeting associated with the legal matter data, the first user device, and the second user device.

14. The method according to claim 12, further comprising:
receiving, from the first user device, an audio response during the virtual meeting based on providing the first question for display to the user interface of the second user device;
identifying another legal rule corresponding to the legal issue and the jurisdiction that has not been satisfied based on the audio response and the legal matter data received from the first user device;
based on analyzing the set of data and identifying the another legal rule, determining a second question; and
providing, to the user interface, the second question for display during the virtual meeting.

15. The method according to claim 14, wherein the audio response is analyzed by an automatic speech recognition model, and wherein the another legal rule is identified based on the automatic speech recognition model analyzing the audio response.

16. One or more non-transitory computer storage media having computer-executable instructions embodied thereon, that when executed by at least one processor, cause the at least one processor to perform a method comprising:
receiving legal matter data;
based on receiving the legal matter data, identifying a legal issue;
retrieving a set of data from at least one database that includes a plurality of legal documents that each have at least one legal rule;
applying the set of data to at least one machine learning algorithm that is trained using training data that includes a plurality of legal rules;
receiving an indication of a virtual meeting associated with the legal matter data, the virtual meeting being associated with at least one attorney; and
based on applying the set of data to the at least one machine learning algorithm, causing to display, at a user interface of a user device, particular legal information.

17. The one or more non-transitory computer storage media of claim 16, further comprising:
based on receiving the indication of the virtual meeting associated with the legal matter data, retrieving, from the at least one database, an attorney profile for the at least one attorney, the attorney profile including a bar license number and at least one image identifier, the attorney profile associated with the user interface displaying the particular legal information;
identifying a jurisdiction for the legal matter data;
determining whether the bar license number corresponds to the jurisdiction identified;
retrieving the set of data based on the jurisdiction identified;
receiving another indication that the virtual meeting associated with the legal matter data has begun;
causing to display the at least one image identifier for display during the virtual meeting; and
causing to display an indication based on determining whether the bar license number corresponds to the jurisdiction identified.

18. The one or more non-transitory computer storage media of claim 17, further comprising:
based on receiving the indication of the virtual meeting associated with the legal matter data, retrieving, from the at least one database, a client profile for a client associated with the virtual meeting, the client profile including location data associated with the client and the legal matter data and historical client data associated with historical legal matter data; and
identifying the jurisdiction further based on the client profile.

19. The one or more non-transitory computer storage media of claim 18, further comprising:
comparing the legal matter data with the historical legal matter data of the client profile;
determining a similar legal issue between the legal matter data and the historical legal matter data; and
causing to display, at the user interface of the user device, the similar legal issue and a selectable link associated with the historical client data and the similar legal issue.

20. The one or more non-transitory computer storage media of claim 19, further comprising causing to display a particular electronic document at the user interface of the user device upon receiving a selection of the selectable link.
